(19) United States
(12) Patent Application Publication
(10) Pub. No.: US 2001/0036863 A1
(43) Pub. Date: Nov. 1, 2001

(54) Gambling machine operation data acquisition and central register system

(76) Inventor: Miroslav Valenta, Uherske-Hradiste (CZ)

Correspondence Address: NOTARO AND MICHALOS, 100 DUTCH HILL ROAD, SUITE 110, ORANGEBURG, NY, 10962-2100, US

(21) Appl. No.: 09/827,984

(22) Filed: Apr. 6, 2001

(30) Foreign Application Priority Data
Apr. 26, 2000 (CZ) 2000-10698

(51) Int. Cl. G06F 17/00

(52) U.S. Cl. 463/41

(57) ABSTRACT

A gambling machine operation data acquisition and central register system comprising at least one collection and transmission module connected to a gambling machine, at least one central register place server and a mobile telephone network providing connection between said module and said central register place server. The collection and transmission module comprises a main processor having an input and output, integral counters connected to said input, electromechanical counters generating signals applied to the integral counters, contact switches circuits connected to said input, control and auxiliary circuits of the gambling machine connected to said input a telephone module connected to said output.

### BACKGROUND OF THE INVENTION

The invention relates to a gambling machine operation data acquisition and central register system, which is especially applicable to slot machines, called also fruit machines, and other winning game machines as well as to lotteries and similar games.

### DESCRIPTION OF THE RELATED ART

At the present time, a data acquisition and central register system is regularly used by numerical lotteries only. A data transfer on-line system is for example employed to collect data from individual betting shops, for organizing so called KENO game or other similar games. Satellite transmissions are mostly applied to rating betting.

Nevertheless, the situation with the gambling machines, such as for example slot machines, is more complicated. Each of such machines is equipped with two systems of counters that are registering put in and paid out monies in accordance with the respective supervision statutory rules. Actual inspection procedure to be performed by the operator and a supervising licensing authority require that the inspection authority appears directly at the place where the slot machine is installed what results in a rather inoperative and time consuming procedure. At this time, no gambling machine operation data acquisition and central register system is known, that would enable a more effective inspection procedure.

### SUMMARY OF THE INVENTION

It is an object of this invention to provide a gambling machine operation data acquisition and central register system which comprises at least one collection and transmission module connected to a gambling machine, at least one central register place server and a mobile telephone network providing connection between said module and said central register place server.

In accordance with the first aspect of the invention the data collection and transmission module comprises a main processor having an input and output, integral counters connected to said input, electromechanical counters generating signals applied to the integral counters, contact switches circuits connected to said input, control and auxiliary circuits of the gambling machine connected to said input a telephone module connected to said output.

Electromechanical counters of the gambling machine are designed as conventional, currently used counters the signals of which are applied to the main processor input, for example over a coin collection counter, a paid out prize counter, a game counter and a refill coins counter. Alternatively, a game counter and the cumulative prize counter-jackpot may be combined.

The contact switches may include a cash box door switch, a control instrument box door switch and a contact terminal board for connection to a jackpot device.

The control and auxiliary circuits monitored through the data acquisition and central registration system may include a service call circuit and a transmission module feeding accumulator control circuit.

Advantageously, as a mobile telephone networks the GSM network may be employed.

To ensure the optimal security of the system the central register place server may be completed by a backup server and both or any of them may be doubled.

The main advantage of the data acquisition and central register system is that an authorized person may observe and inspect the operation of particular gambling machines, or in the future so called terminal games, as the case may be, including the respective cash flows, from one single place. This enables a centralized, continuously performed and high operative inspection of the put in and paid out monies (and of other data reflecting the operation of the machine) with a great number of gambling machines in operation. The system also provides for a high effective and centralized inspection of a great number of gambling machines with regard to criminal acts such as theft, burglary etc. The inspection results in the elimination of an unauthorized manipulating the gambling machines counters and enables the regular inspection of the gambling machines operations including the comparison of their outputs etc.. Moreover, such inspection is accompanied by the effective protection of the proceeds achieved, not only for the benefit of the operator but also for that of the supervising licensing authorities (municipalities). The result is a substantial elimination of the attempts to cut down the proceeds and of the subsequent evasion of respective charges, levies taxes etc. The system further enables an operative inspection of the services rendered by the respective service organizations.

The above described advantages are achieved by relatively simple and low cost design solution according to the invention which require only minor intervention into the conventional gambling machine design. The costs incurred with the information transmission to the central register place may also be relatively low if the transmission conditions are properly chosen.

### BRIEF DESCRIPTION OF THE DRAWINGS

The substantial features of the invention and its preferred embodiment will now be described with reference to the accompanying drawings where

FIG. 1 shows the entire functional chart of a gambling machine operation data acquisition and central register system;

FIG. 2 shows a block diagram of a transmission module for the transmission of gambling machine operation data;

FIG. 3 shows a block diagram of a transmission module for the jackpot data transmission.

### DESCRIPTION OF THE PREFERRED EMBODIMENT

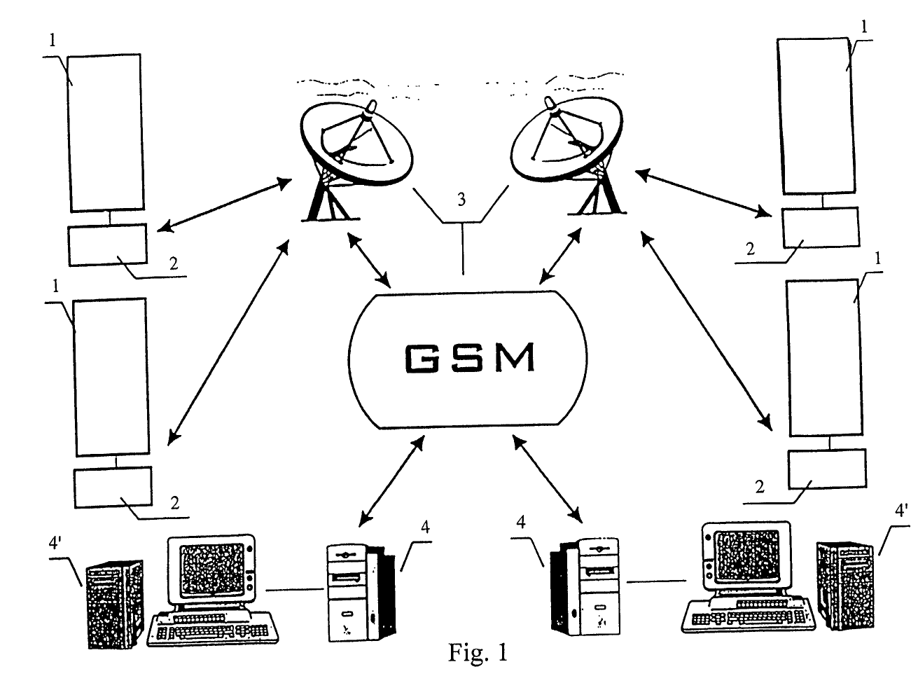

An embodiment of a gambling machine operation data acquisition and central register system shown in FIG. 1 consists of four collection and transmission modules 2 each of which being connected to or incorporated in one of the four monitored gambling machines 1 and linked over a mobile telephone GSM network 3 to central register place servers 4. In this embodiment of the invention the central register place server 4 is completed by a backup server 4′. For the sake of security and reliability of the operation of gambling machines 1 the whole system of the central register place servers 4 4′ is doubled.

Each collection and transmission module 2 is designed to continuously process the on-line status data from each respective gambling machine 1 and to convert it into a transmission signal that may be encoded. Such data are transferred through the GMS network into a central register place in the predetermined intervals. The data transmission may run also reversibly with gambling machines properly equipped for that purpose, and also outside the predetermined intervals.

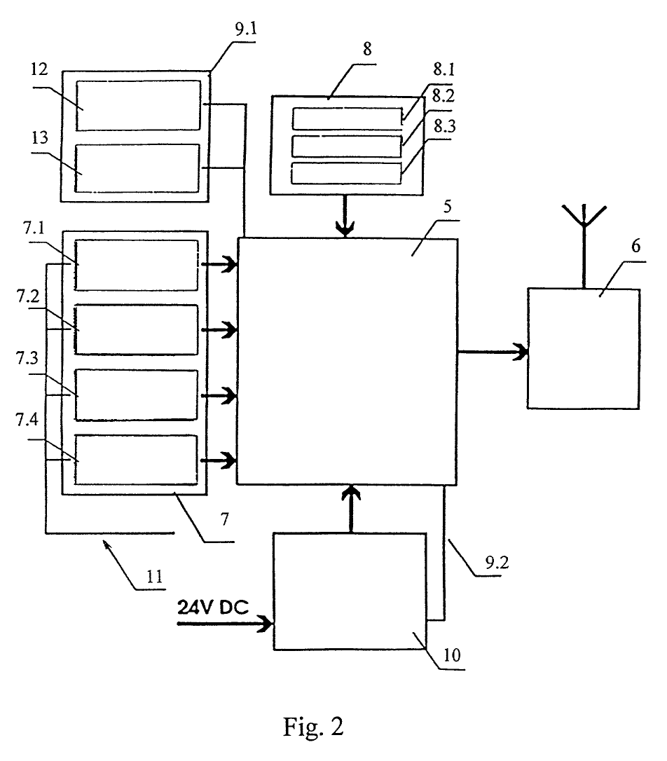

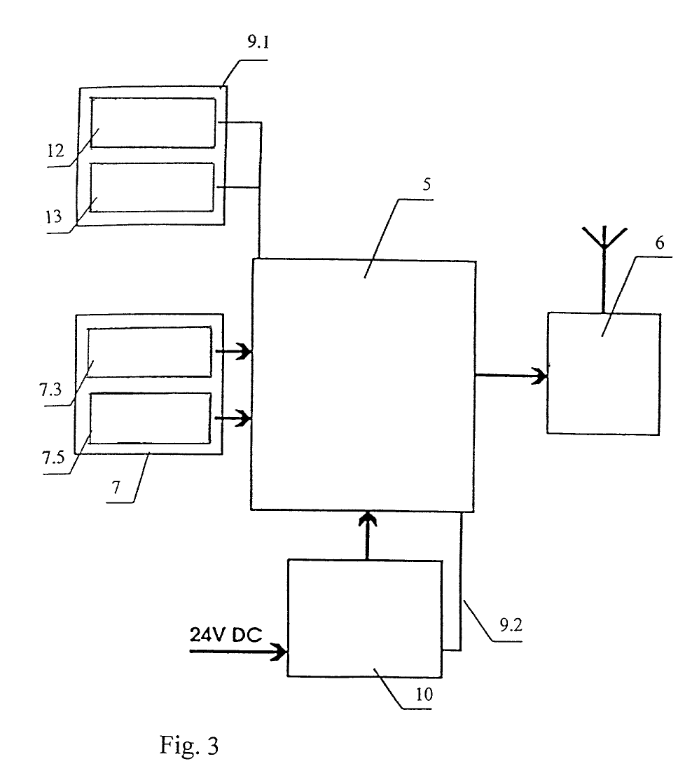

A collection and transmission module 2 shown in FIG. 2 and 3 comprises a feeding unit 10, a main processor 5 and a telephone module 6 (GSM) connected to the output of the main processor 5. To the input of the main processor 5 integral counters 7 (7.1, 7.2, 7.3, 7.4, 7.5) receiving signals from conventional electromechanical counters 11, not shown in the drawings, as well as circuits of contact switches 8 (8.1, 8.2, 8.3), and control and auxiliary circuits 9.1, 9.2 of the gambling machine 1 are connected.

The feeding unit 10 of the collection and transmission module 2 is realized as an accumulator charged by a DC 24 volts source. The DC source is connected to internal circuits of the gambling machine 1.

All operations relating to the acquisition of data from particular components of the gambling machine 1 including the processing and subsequent transfer thereof to the telephone module 6 are controlled by the main processor 5. The telephone module 6 provides for the transmission of the data over the GSM networks.

In the embodiment of the collection and transmission module 2 for the transmission of data from the gambling machine according to FIG. 2, the following devices are connected to the input of the main processor 5:

the integral counters 7 receiving signals from the electromechanical counters 11—specifically:

a put in coins counter 7.1 (PUT-IN counter)

a prize paid out counter 7.2 (PAID-UP counter)

a game counter 7.3 (GAME counter)

a refill counter 7.4 (REFILL counter)

the circuits of individual contact switches 8—specifically:

a cash box door contact switch 8.1

a control instrument box door switch 8.2

a contact terminal board 8.3 for connection to a jackpot device;

the control and auxiliary circuits 9.1, 9.2—specifically:

a service call circuit 9.1 (a service call button 12 for attending the gambling machine 1 in the event of a defect, upon unauthorized access to the machine etc.) for the emergency calling of a serviceman. The reception of this information is signaled by a LED diode 13.)

a feeding accumulator control circuit 9.2.

FIG. 3 shows a block diagram of the collection and transmission module 2 for the transmission of the jackpot data. According to this embodiment of the invention, the collection and transmission module 2 comprises like the collection and transmission module in FIG. 2 a feeding unit 10, a main processor 5 and a telephone module 6 connected to the output of the main processor 5. To the input of the main processor 5, integral counters 7 and control and auxiliary circuits 9.1, 9.2 of the gambling machine 1 are connected. In this embodiment, the integral counters 7 include a game counter 7.3 and a jackpot, i.e. the cumulative paid out prize, counter 7.5.

Other equipment and arrangements of the collection and transmission module are similar to those in the preceding embodiment (see the block diagram in FIG. 2 and the respective description thereof).

1. A gambling machine operation data acquisition and central register system comprising at least one collection and transmission module connected to a gambling machine at least one central register place server and a mobile telephone network providing connection between said module and said central register place server.

2. A gambling machine system of claim 1 characterized in that the collection and transmission module comprises a
main processor having an input and output,
integral counters connected to said input,
electromechanical counters generating signals applied to the counters,
contact switches circuits connected to said input,
control and auxiliary circuits of the gambling machine connected to said input
a telephone module connected to said output.

3. A gambling machine system of claim 2 characterized in that the integral counters include a coin collection counter, a paid out prize counter, a game counter and a refill coins counter.

4. A gambling machine system of claim 2 characterized in that the integral counters consist of a game counter and a jackpot counter.

5. A gambling machine system of claim 2 characterized in that the contact switches include a cash box door switch, instrument control box door switch and a jackpot pay out switch.

6. A gambling machine system of claim 2 characterized in that the control and auxiliary circuits consist of a service call circuit and a transmission module feeding accumulator control circuit.

7. Gambling machine system of claim 2 characterized in that the mobile telephone network is the GSM network

8. A gambling machine system of claim 1 characterized in that the central register place server includes a backup server.

9. A gambling machine system of claim 1 characterized in that the central register place server is doubled.
